(19) United States
(12) Patent Application Publication
(10) Pub. No.: US 2021/0012620 A1
(43) Pub. Date: Jan. 14, 2021

(54) CASINO WAGERING SYSTEM

(71) Applicants: Hwei-Wen Wayne Hong, Alameda, CA (US); Ivan E Hong, Alameda, CA (US)

(72) Inventors: Hwei-Wen Wayne Hong, Alameda, CA (US); Ivan E Hong, Alameda, CA (US)

(21) Appl. No.: 16/597,785

(22) Filed: Oct. 9, 2019

Related U.S. Application Data
(60) Provisional application No. 62/872,288, filed on Jul. 10, 2019.

(51) Int. Cl. G07F 17/32

(52) U.S. Cl. CPC G07F 17/3293; G07F 17/3244

(57) ABSTRACT

A method, system, and computer readable storage medium to implement a poker-based entertainment system which pits a player against a dealer. The player is provided two cards plus two community cards, and the dealer is provided two cards plus the same two community cards, and the player and dealer each make a best 3 card poker hand out of their respective four cards. Wagers can be resolved based on dealer's qualify hand, and a relationship between the player's hand and the dealer's hand.

### CROSS REFERENCE TO RELATED APPLICATIONS

This application claims benefit of provisional application 62/872,288, filed on Jul. 10, 2019, which is incorporated by reference herein in its entirety for all purposes. All features described in the provisional applications can be combined in any manner whatsoever with the features described herein.

### BACKGROUND OF THE INVENTION

### Field of the Invention

The present general inventive concept is directed to a method, apparatus, and computer readable storage medium directed to a wagering game.

### Description of the Related Art

Casino games (both played in live format and electronic format) are a billion-dollar industry. The industry is also striving to produce new and exciting wagering methods which players may find fresh and exciting and the house (casino) finds profitable.

### SUMMARY OF THE INVENTION

It is an aspect of the present invention to provide an exciting casino system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a casino wagering game, according to an embodiment;

FIG. 2A is a drawing of a gaming table according to an embodiment;

FIG. 2B is a drawing of a betting layout, according to an embodiment;

FIG. 3A is a drawing illustrating each player's betting area on a gaming table according to an embodiment;

FIG. 3B is a block diagram illustrating an electronic player tracking system associated with each gaming table, according to an embodiment;

FIG. 4A is a block diagram illustrating exemplary hardware that can be used to implement an electronic version of the methods described herein; and

FIG. 4B is a block diagram illustrating an exemplary network configuration to implement a player playing an online version of the methods described herein;

FIG. 5 is a drawing illustrating initial stages of the game, according to an embodiment;

FIG. 6 is a drawing illustrating further stages of the game, according to an embodiment; and

FIG. 7 is a drawing illustrating final stages of the game, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The inventive concept is a method, apparatus, and computer readable storage directed to implementing a poker-type card game in which players can play against a dealer/house. Some poker-based games are known in the art, for example see US patent publication 20130029738, which is incorporated by reference herein in its entirety. The game can be played physically (in a brick and mortar casino with physical cards and chips) and it can also be played in electronic form (on a computer or mobile computing device (e.g., cell phone)) which can be an app, playing at an online casino, on a digital card table, on an electronic gaming machine (EGM), etc. Furthermore, the progressive component of the game can be played throughout any 4G or 5G networks across different platforms. All programs and assets to implement an electronic version of the features described herein can also be stored on any non-transitory computer readable storage medium.

Table I below represents one possible set of rules for the inventive concept. The resolution of high/low (win/lose) hands is based upon the well-known poker rankings. In the case of 3 card poker, the ranking orders from highest (best) to lowest (worst) poker hands are: royal flush>straight flush>3 of a kind>straight>flush>pair>high card.

### Table I

1) The game is played between a player and the dealer's hand.
2) Each player must place a mandatory ante wager and any optional side wagers before the hand begins.
3) Each player and the dealer receive a first hole card, face-up.
4) At this point, each player must make a decision and choose to wager either a lx (match the ante wager mount) or 2x (twice the ante wager amount) play wager (1× or 2× of the ante wager amount) or fold their hand. If a player folds their hand, the dealer collects the ante wager but any optional side wagers remain in play.
5) After the players have made their decisions, each player and dealer receives a second hole card and the two (2) card community board is revealed.
6) Each player and the dealer form their best three (3) card poker hand from their two (2) hole cards and the two (2) card community board.
7) Each player hand is then compared to the dealer hand and the main game wagers and any optional side wagers are resolved.
8) The main game wagers are resolved as follows:
9) The dealer hand qualifies with an Ace-high or better hand.
10) If the dealer's hand does not qualify, all remaining ante wagers push.
11) If the dealer's hand does qualify, then:
12) If a player's hand beats the dealer's hand, the ante wager is paid even money.
13) If a player's hand loses to the dealer's hand, the ante wager is lost.
14) If a player's hand ties the dealer's hand, the ante wager pushes.
15) Regardless of whether or not the dealer's hand qualifies, the player's play wager wins odds according to the following paytables: Player wins with a royal flush (10:1 for Paytable A and 15:1 for Paytable B) Player wins with a straight flush (5:1 for Paytable A and 5:1 for Paytable B); Player wins with a 3 of a kind (3:1 for Paytable A and 3:1 for Paytable B). Player wins with other hands (1:1 for Paytables A and B).
The play wager payouts for player's winning hands are summarized below:

| Player's Winning Hand | Paytable A | Paytable B |
|---|---|---|
| Royal Flush | 10 to 1 | 15 to 1 |
| Straight Flush | 5 to 1 | 5 to 1 |
| 3 of a Kind | 3 to 1 | 3 to 1 |
| Others | 1 to 1 | 1 to 1 |

Of course, the rules in Table I are one set of example rules, and it can be appreciated that other variations of rules (including payouts) can be used as well.

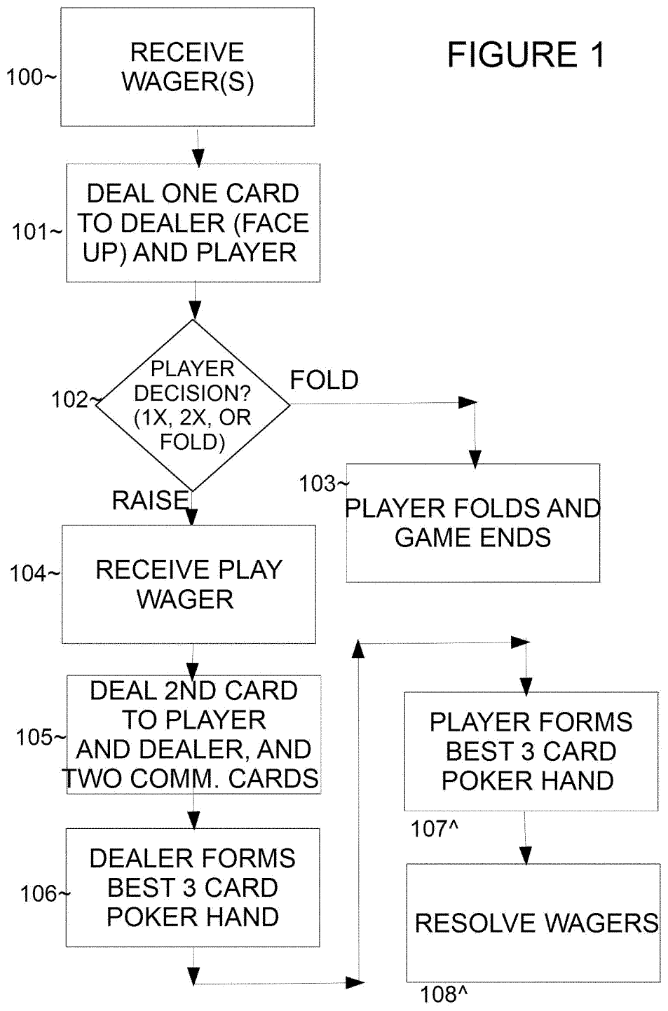

FIG. 1 is a flowchart illustrating an exemplary method of implementing a casino wagering game, according to an embodiment.

The game can begin with operation 100, wherein the player makes wagers before the game begins. The player would place a mandatory ante wager. In the physical version, the player would place the ante wager (and all wagers) using physical chips on a physical betting area on a physical table. In the electronic version, the player could place the ante wager (and all wagers) using a graphical user interface to select virtual chips (or other icon) for the wagers. In addition to the ante wager, the player can also place any side wagers which are typically optional.

From operation 100, the method proceeds to operation 102, which deals one card to the dealer out of the deck(s) (physical deck for the physical game and virtual deck for the electronic version) and one card to the player. The dealer's one card is dealt face up so all players can view its value. The player's card can be dealt face up or face down, although if dealt face down the player receiving the card must be able to view it.

From operation 101, the method proceeds to operation 102, wherein the player makes a decision (which typically is made based on the knowledge of the dealer's card and the player's card). The player can choose one option out of the following three options: 1) make a play wager equal to the ante wager; 2) make a player wager which is double the ante wager; 3) fold. The dealer's card should be face up so the player can utilize this information when making his/her decision. In addition, the player's card should either be face up or viewable by the respective player so that the player can utilize the value of his/her card when making the decision.

If the player folds in operation 102, then the method proceeds to operation 103 and the player loses his/her ante wager and the game ends (although any side wagers that the player has made are still live and would still be resolved at the end of the game).

In operation 102, if the player decides to play or raise, then the method proceeds to operation 104, which receives a play wager from the player. The player chooses to make the play wager either equal in value to the ante wager or double the ante wager (when the player feels he/she has a relatively strong advantage).

From operation 104, the method proceeds to operation 105, which deals a second card to the player and a second card to the dealer (face up). The second player card can be dealt face up or face down (so long as the respective player can view the card). Two community cards are also dealt face up. This completes all of the cards that are dealt. At the end of the deal, before wagers are resolved, all cards should be turned face up.

From operation 105, the method proceeds to operation 106, wherein the dealer forms the best three card poker hand using the four available cards to the dealer (the dealer's first card dealt in operation 101, the dealer's second card dealt in operation 105, and the two community cards dealt in operation 105). All of the dealer's cards should be face up, but if not then they should all be turned face up.

From operation 105, the method proceeds to operation 107, wherein the player forms the best three card poker hand using the four available cards to the player (the player's first card dealt in operation 101, the player's second card dealt in operation 105, and the two community cards dealt in operation 105). If the player's two cards are not face up now, then they should be turned face up.

Note if multiple players are playing against the dealer and the first cards are dealt face-up, then after the first cards have been dealt to all players, each player will see all up cards, thus having more information to help him/her in deciding how to make the play wager.

Note that when multiple players are playing at the table, there can be two ways to deal player cards. In one embodiment, all of the players would share the same two player cards (“baccarat style”). In another embodiment (preferred), each player would be dealt their own respective two cards for use for only that respective player.

From operation 107, the method proceeds to operation 108, which resolves the wagers made (the ante wager placed in operation 100, any side wagers placed in operation 100, and the play wager placed in operation 104). The ante and play wagers are resolved based upon the dealer's best 3 card poker hand (formed in operation 106) and the player's best 3 card poker hand (formed in operation 107). When the wagers are resolves, all cards should be revealed (turned face up) if not already. Note that the ante wager is returned if the dealer's hand is not qualified which in one embodiment is defined as lower than Ace-high. When the dealer's hand is Ace-high or better, the ante wager receives even-money action. That is the ante wager is paid even money if the player's hand beats the dealer's hand and the ante wager loses if the dealer's hand beats the player's hand.

Note that the play wager would pay a bonus payout if the player's winning poker hand is a predetermined hand. For example, if the player's winning 3 card poker hand is a royal flush the play wager would pay 15:1; a straight flush pays 5:1; 3 of a kind pays 3:1; any other winning hand pays 1:1.

Note that in another embodiment, other amounts of cards can be dealt as well. For example, three community cards can be dealt, and the player's hand is the five-card hand formed by the three community cards plus two player's cards and the dealer's hand is the five card hand formed by the three community cards plus the two dealer's cards.

In a further embodiment, five community cards can be dealt, and the player's hand is the best five card hand out of the five community cards plus the player's two cards and the dealer's hand is the best five card hand out of the five community cards plus the dealer's two cards.

In a further embodiment, there can be a progressive side wager, in which the player can make a progressive wager of $1, $2, $5, and which can pay based on the outcomes of player's 7 card poker hands whereby a royal flush can pay 100% of the progressive pool. In the case of the embodiment where player gets two cards, dealer gets two cards and there are two community cards, an extra card can be dealt on the side so that there would be seven cards for each player and the progressive wager can be based on the best five card poker hand out of the seven cards dealt.

In a further embodiment, the player's progressive wager can be resolved based upon the 5-card best poker hand out of the 7 cards: 2 hole cards, 2 deals cards and 3 community cards dealt.

In a further embodiment, a player's progressive wager can be offered on the table. The player's progressive wager can be resolved based upon the 5-card best poker hand out of the 7 cards: 2 hole cards and 5 community cards.

In a further embodiment, side wagers can be offered. An optional “bad beat” bonus is offered on the final outcome of the player's vs the dealer's 3-card poker hands. The rank of the losing hand determines the payout, as specified by the pay table. This “bad beat” bonus is described as “2-Way”, because it doesn't matter if the player hand or the dealer hand loses; only the rank of the losing hand determines the outcome. The pay tables for the 2-Way Bad Beat Bonus are listed below. The return for these side wagers is computed over all possible two-card community boards, two player hole cards, and two dealer hole cards.

TABLE II
2-Way Bad Beat

| Losing Hand Rank | Paytable A | Paytable B | Paytable C |
|---|---|---|---|
| Straight Flush | 1000 | 1000 | 500 |
| Three of a Kind | 300 | 200 | 200 |
| Straight | 20 | 20 | 25 |
| Flush | 5 | 5 | 5 |
| Pair A | | | 2 |
| Hit Rate | 8.280% | 8.280% | 9.677% |
| player Net | −8.7909% | −11.9911 | −7.4833% |

Another optional side wager can be a two-card bonus side wager. An optional Two Card Bonus side wager is available on the player's two hole cards. Three available Pay Tables for the Two Card Bonus are listed below. The return for these side wagers is computed over all possible player two hole card outcomes, and the last row shows the house edge of the side wager. Table III below illustrates some sample paytables for the two-card bonus side wager.

TABLE III
Player's 2 Hole Card Bonus

| Player's 2 Hole Cards | Paytable A | Paytable B | Paytable C |
|---|---|---|---|
| AA | 30 | 30 | 30 |
| Suited Blackjack | 15 | 20 | 15 |
| High Pair (T-K) | 10 | 10 | 10 |
| Unsuited Blackjack | 5 | 5 | 6 |
| Low Pair (2-9) | 3 | 3 | 3 |
| Hit Rate | 10.709% | 10.709% | 10.709% |
| Player Net | −10.558% | −4.525% | −6.938% |

In a further embodiment, an optional four card poker bonus side wager is available for each player that pays on the four-card poker hand made by the player's two hole cards and two community board cards. Two Pay Tables for the Four Card Poker Bonus are listed in the tables below. The return for these side wagers are computed over all possible 4-card hand outcomes. Table IV illustrates some examples for a four-card poker bonus side wager.

TABLE IV
4 Card Poker Bonus

| Outcome | Payout | Return | Payout | Return |
|---|---|---|---|---|
| Royal Flush | 500 | 0.73876% | 300 | 0.44325% |
| Four-of-a-Kind | 200 | 0.96038% | 200 | 0.96038% |
| Straight Flush | 100 | 1.47751% | 100 | 1.47751% |
| Three-of-a-Kind | 20 | 18.43938% | 20 | 18.43938% |
| Flush | 15 | 15.60255% | 15 | 15.60255% |
| Straight | 10 | 10.23917% | 10 | 10.23917% |
| Two Pairs | 5 | 5.18607% | 5 | 5.18607% |
| High Pair (T's thru A's) | 2 | 23.40382% | 2 | 23.40382% |
| Hit Rate | | 15.74624% | | 15.74624% |
| player Net | | −8.20611% | | −8.50162% |

Note that poker ranks can be ranked according to standard poker ranks. For example, Table V below shows standard three card poker hands ranked from highest (top) to lowest (bottom)

### Table V

Straight flush
Three of a kind

### Straight

### Flush

### Pair

High card

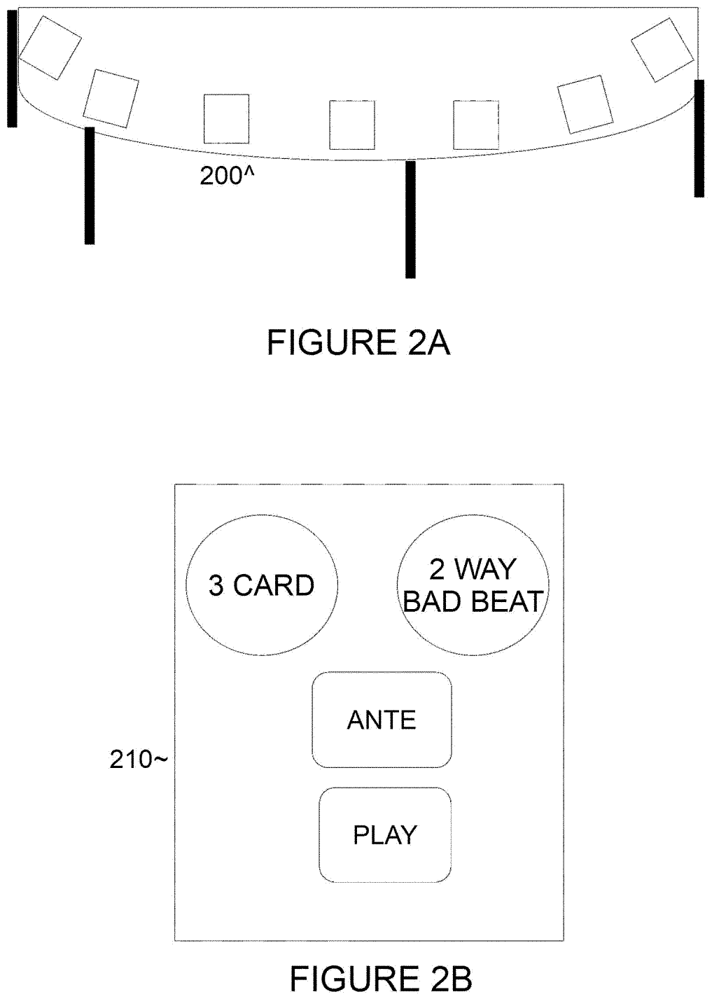

FIG. 2A is a drawing of a gaming table according to an embodiment.

A physical gaming table 200 has seven seats (although of course it can accommodate any other number) and seven individual betting areas.

FIG. 2B is a drawing of a betting layout, according to an embodiment.

An individual betting layout 210 for an embodiment, shows player's betting areas (can be circles or any other shape) such as ante betting area (for the ante wager), play betting area (for the play wager), and betting circles for the 3 card poker side wager and the 2 way bad beat. Of course, whatever side wagers would be offered would have their own respective betting circles.

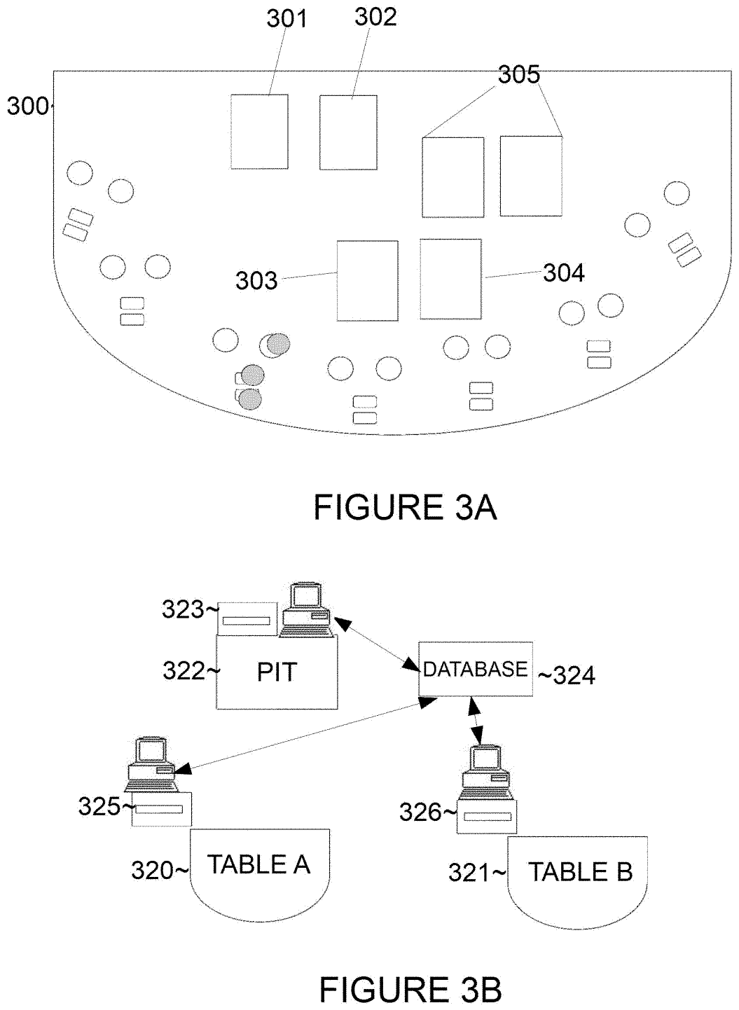

FIG. 3A is a drawing illustrating a gaming table, according to an embodiment.

A physical gaming table 300 (typically made of wood with felt on top with the layout imprinted on it) is used to play the game in a physical real world casino. One example of a table that can be used in a physical casino is illustrated in U.S. Design patent D263,975 which is incorporated by reference herein in its entirety. The layout on top of the felt has imprinted on it seven betting areas as illustrated in FIG. 3A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players at the table play simultaneously.

Shown is only one player at the table playing, third position from the left, who made the ante wager, the play wager, and one of the side wagers. Shown is the player's initial card 303, the player's final card 304, the dealer's initial card 301, the dealer's final card 302, and the community cards 305. The player has four cards at his/her disposal to make a best three card poker hand (the player's hand) using cards 303, 304, 305. The dealer also has four cards at his/her disposal to make a best three card poker hand (the dealer's hand) using cards 301, 302, 305.

Also not pictured in FIG. 3A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 3A is an optional shoe which the cards can be placed into and dealt out of by the dealer, such as the shoe described in U.S. Pat. No. 4,457,512 which is incorporated by reference herein in its entirety.

FIG. 3B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

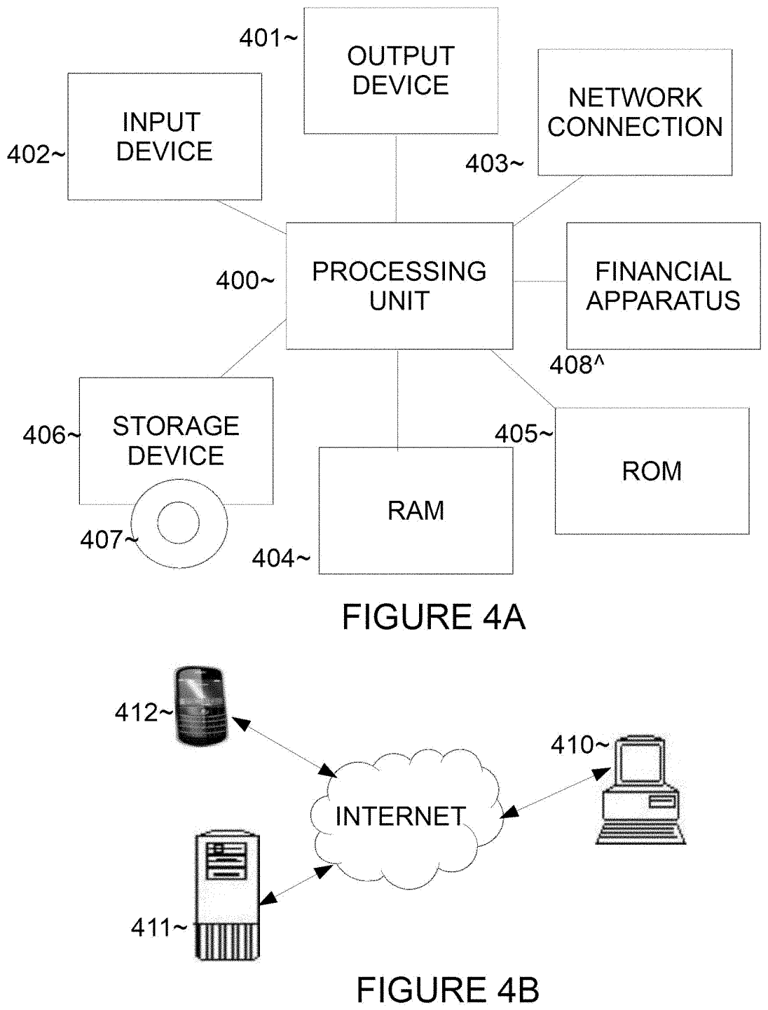

A gaming table A 320 (which can be used to play any method described herein) and a gaming table B 321 (which can be used to play any method described herein) can be associated with a pit 322 (which has its own computer) which has a card reader 323 to read the electronically encoded information on a player's card (the card reader can also be located at the tables themselves) and transmit the information to an associated computer which can communicate information contained on the player's card (e.g., an identification number of the player associated with the card) to the electronic database 324 along with play data relating to the player who owns the player's card. Table A 320 has its own card reader 325 and associated computer (the one next to card reader 325 which receives information from the card reader 325) and table B 321 also has its own card reader 326 and associated computer (the one next to card reader 326 which receives information from the card reader 526). The computers at table A 320 and table B 321 are connected to the electronic database 324. Casino employees can enter data regarding each player's play (for those players that present a players card) into a computer at the table or at the pit which transmits the play data (e.g., average bet/wager amount, time of play, etc.) to the electronic casino database 324 that stores playing history information for players at the casino. The computers illustrated in FIG. 3B can all have the structure as illustrated in FIG. 4A.

FIG. 4A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety. 54 A processing unit 400 (such as a microprocessor and any associated components) is connected to an output device 401 (such as an LCD monitor, touch screen, CRT, etc.) which is used to display to the player any aspect of the method, and an input device 402 (e.g., buttons, a touch screen, a keyboard, mouse, etc.) which can be used to input from the player any decision made by the player. The output device 401 would display virtual representations of all aspects of the game (e.g., cards, chips, table, etc.) All methods described herein can be performed by the processing unit 400 by loading and executing respective instructions. The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a DVD-drive, CD-ROM, flash memory, etc. Multiple such processing units can also work in collaboration with each other (in a same or different physical location). A non-transitory computer readable storage medium 407 can store a program which can control the electronic device to perform any of the methods described herein and can be read by the storage device 406. The processing unit 400 can also be connected to a financial apparatus 408 which can receive cash and convert the received cash into playable credits for use by the player when playing the electronic device. When the player decides to cash out any remaining credits, the financial apparatus 408 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 4B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 410 (e.g., cell phone, tablet, PC, etc.) can connect to a server 411 (which can have the structure illustrated in FIG. 4A) using a computer communications network such as the Internet. The server 411 hosts an online casino which determines the outcomes of the game and serves the outcomes to the computer 410 so the computer 410 displays the outcomes to the player. Other users can also play at the online casino hosted by the server 411 simultaneously, such as using a cell phone (or any mobile device) 412 with wireless internet connectivity. Any number of players (e.g., 1 to 100 or more than 100) can be connected to the internet and can play simultaneously on the sever 411 even though these players are all located in different physical locations.

Note that if the progressive wager is offered, utilizing the integrated network architecture described in FIGS. 3B, 4A and 4B, a casino can seamlessly join multiple electronics or physical tables together to generate a much more sizable jackpot. Furthermore, the linkage of this game with other poker-based games, including 3 Card Poker, Pai-Gow Poker and Ultimate Texas Hold'em can be readily developed. Also, multiple casinos can be networked for the even higher progressive prize.

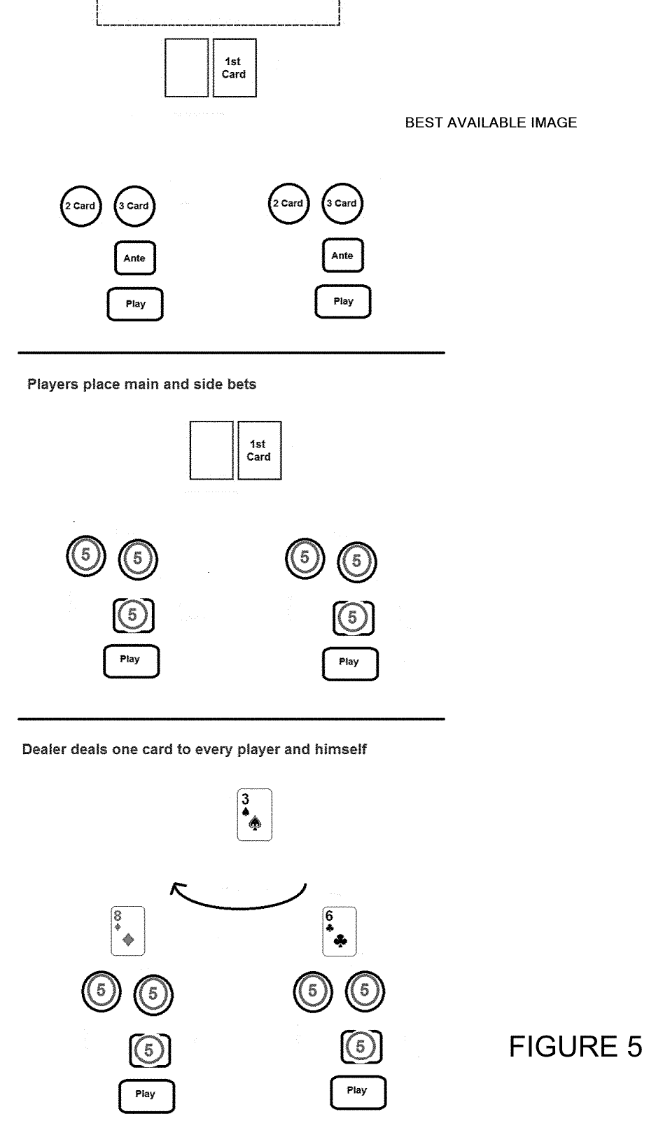

FIG. 5 is a drawing illustrating initial stages of the game, according to an embodiment.

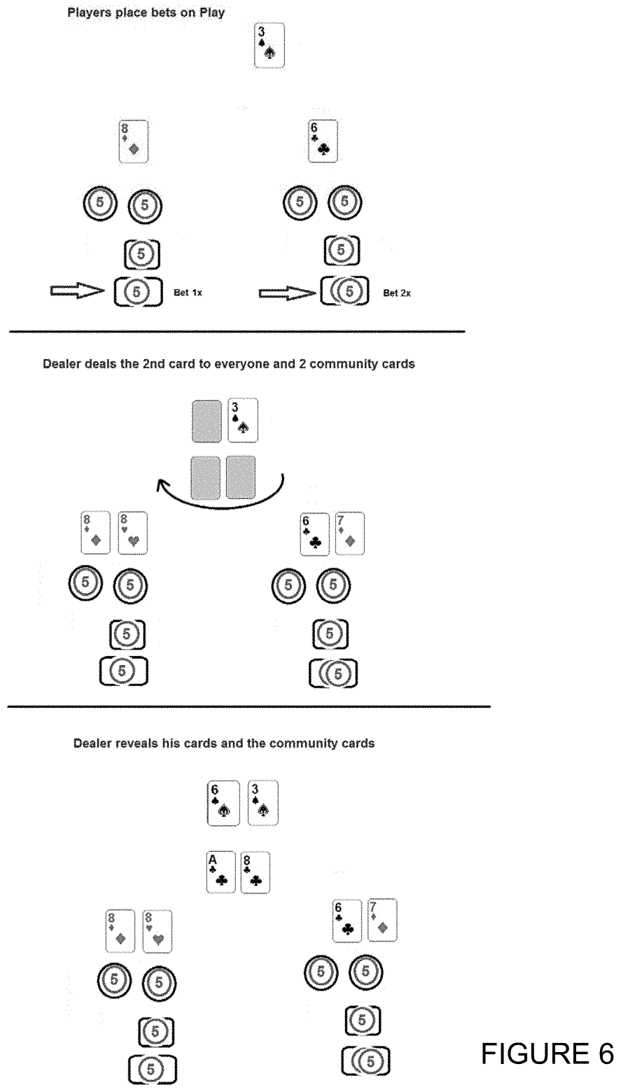

FIG. 6 is a drawing illustrating further stages of the game, according to an embodiment.

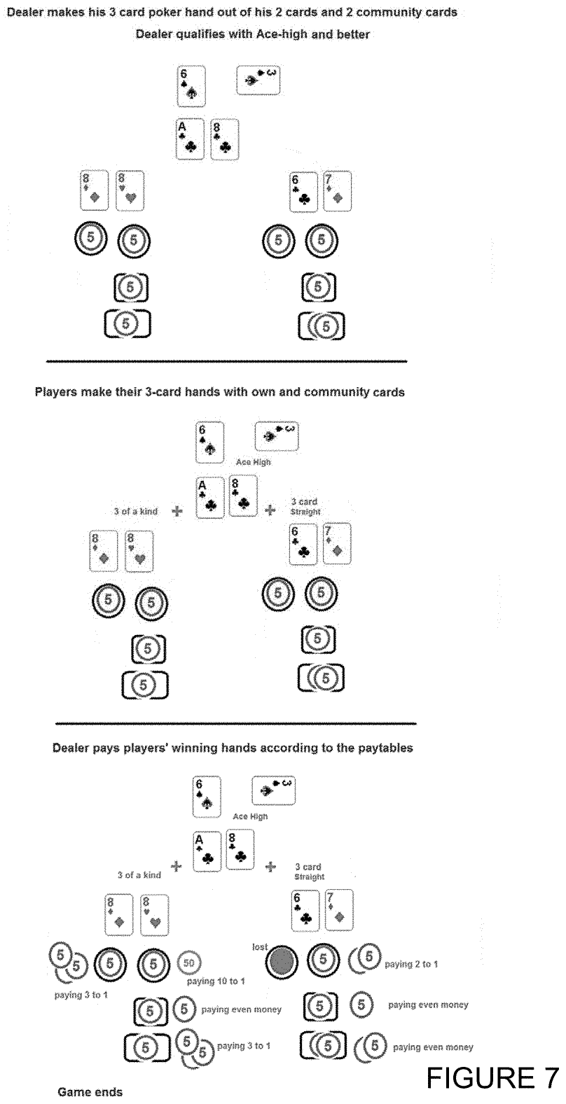

FIG. 7 is a drawing illustrating final stages of the game, according to an embodiment.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Hands can be ranked according to standard poker rankings. Further, when a hand is compared to another hand, it is actually the rank of the hands that are compared. Thus, if a player's hand beats a dealer's hand, this means that the best rank of the player's hand is greater than the best rank of the dealer's hand.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real-life image of that card. In addition, a player's hand can also, in some circumstances, be synonymous with the rank, for example if “a players hand is at least ace-high” this would translate to determining whether the best rank of the player's hand is at least ace-high.

Methods described herein can also be played on a physical table using physical cards and physical chips used to place wagers on a physical table. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins. Note that “bet” and “wager” are used synonymously herein (both as nouns and verbs).

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation. All features in all documents incorporated by reference herein can be combined with any feature(s) described herein, and also with all other features in all other documents incorporated by reference, without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a wagering game, the method comprising:
executing, on a processing unit, computer readable instructions that perform:
receiving an ante wager from a player;
display a player's initial set of cards selected randomly and a dealer's initial set of cards selected randomly;
offering a decision to the player, wherein the decision is a selection in a set comprising raise 1× ante, raise 2× ante, and fold;
receiving a play wager from the player;
displaying a player's final set of cards selected randomly and a dealer's final set of cards selected randomly;
displaying a set of community cards;
determining a player's hand using a best N card poker hand using the player's initial set of cards and the player's final set of cards and the community cards;
determining a dealer's hand using a best N card poker hand using the dealer's initial set of cards and the dealer's final set of cards and the community cards;
providing a set of predetermined ante wager resolution rules which comprises determining whether the dealer's hand qualifies with at least a predetermined rank, if the dealer does not qualify then the ante wager pushes, and if the dealer does qualify then the ante wager is paid even money if the player's hand beats the dealer's hand and the ante wager loses if the dealer's hand beats the player's hand;
providing a set of predetermined play wager resolution rules which comprise if the player's hand beats the dealer's hand, the play wager is paid a payout based on a rank of the player's hand, and if the player's hand does not beat the dealer's hand then the play wager loses;
resolving the ante wager using the predetermined ante wager resolution rules; and
resolving the play wager using the predetermined play wager resolution rules.

2. The method as recited in claim 1, wherein N=3, the player's initial set of cards is exactly one card, the dealer's initial set of cards is exactly one card, the player's final set of cards is exactly one card, the dealer's final set of cards is exactly one card, and the community cards are exactly two cards.

3. The method as recited in claim 1, wherein the predetermined rank is ace high.

4. The method as recited in claim 1, wherein the play wager resolution rules further comprise paying a bonus to the player when the player's winning hand is a predetermined rank.

5. An apparatus to implement a wagering game, the apparatus comprising:
an electronic input unit;
an electronic output unit;
a circuit connected to the input unit and the output unit, the circuit comprising at least one processor, the at least one processor connected to a non-transitory storage device which stores computer readable instructions which are programmed to cause the at least one processor to:
receive an ante wager from a player;
display a player's initial set of cards selected randomly and a dealer's initial set of cards selected randomly;
offer a decision to the player, wherein the decision is a selection comprising raise 1× ante, raise 2× ante, and fold;
receive an action from the player from a set comprising receive a play wager and fold, wherein if the action is fold then the player loses the ante wager, wherein if the action is receive the play wager then the play wager is received from the player; display a player's final set of cards selected randomly and a dealer's final set of cards selected randomly;
display a set of community cards;
determine a player's hand using a best N card poker hand using the player's initial set of cards and the player's final set of cards and the community cards;
determine a dealer's hand using a best N card poker hand using the dealer's initial set of cards and the dealer's final set of cards and the community cards;
resolve the ante wager based on rules which provide: determine whether the dealer's hand qualifies with at least a predetermined rank, if the dealer does not qualify then the ante wager pushes, and if the dealer does qualify then the ante wager is paid even money if the player's hand beats the dealer's hand and the ante wager loses if the dealer's hand beats the player's hand; and
resolve the play wager based on rules which provide: if the player's hand beats the dealers hand, the play wager is paid a payout based on a rank of the player's hand, and if the player's hand does not beat the dealer's hand then the play wager loses.

6. The apparatus as recited in claim 5, wherein the computer readable instructions are further configured such that N=3, the player's initial set of cards is exactly one card, the dealer's initial set of cards is exactly one card, the player's final set of cards is exactly one card, the dealer's final set of cards is exactly one card, and the community cards are exactly two cards.

7. The apparatus as recited in claim 5, wherein the computer readable instructions are further configured such that the predetermined rank is ace high.

8. The apparatus as recited in claim 5, wherein the computer readable instructions are further configured such that the play wager resolution rules further comprise paying a bonus to the player when the player's winning hand is a predetermined rank.

9. A method for implementing a wagering game, the method comprising:
providing at least one physical deck(s) of cards;
receiving an ante wager from a player using physical chips;
receiving an ante wager from a player;
dealing, out of the at least one physical deck(s) of cards, a player's initial set of cards selected randomly and a dealer's initial set of cards selected randomly;
offering a decision to the player, wherein the decision is a selection in a set comprising raise 1× ante, raise 2× ante, and fold;
receiving a play wager from the player;
dealing, out of the at least one physical deck(s) of cards, a player's final set of cards selected randomly and a dealer's final set of cards selected randomly;
dealing, out of the at least one physical deck(s) of cards, a set of community cards;
determining a player's hand using a best N card poker hand using the player's initial set of cards and the player's final set of cards and the community cards;
determining a dealer's hand using a best N card poker hand using the dealer's initial set of cards and the dealer's final set of cards and the community cards;
providing a set of predetermined ante wager resolution rules which comprises determining whether the dealer's hand qualifies with at least a predetermined rank, if the dealer does not qualify then the ante wager pushes, and if the dealer does qualify then the ante wager is paid even money if the player's hand beats the dealer's hand and the ante wager loses if the dealer's hand beats the player's hand;
providing a set of predetermined play wager resolution rules which comprise if the player's hand beats the dealer's hand the play wager is paid a payout based on a rank of the player's hand, and if the player's hand does not beat the dealer's hand then the play wager loses;
resolving the ante wager using the predetermined ante wager resolution rules; and
resolving the play wager using the predetermined play wager resolution rules.

10. The method as recited in claim 9, wherein N=3, the player's initial set of cards is exactly one card, the dealer's initial set of cards is exactly one card, the player's final set of cards is exactly one card, the dealer's final set of cards is exactly one card, and the community cards are exactly two cards.

11. The method as recited in claim 9, wherein the predetermined rank is ace high.

12. The method as recited in claim 9, wherein the play wager resolution rules further comprise paying a bonus to the player when the player's winning hand is a predetermined rank.
